(19) United States
(12) Patent Application Publication
(10) Pub. No.: US 2007/0272678 A1
(43) Pub. Date: Nov. 29, 2007

(54) Apparatus and Method of Computer Component Heating

(76) Inventors: Yitzhak Meyuchas, Tel Aviv (IL); Felix Barmoav, Tel Aviv (IL); Yaakov Moseri, Tel Aviv (IL); Yossef Schneider, Tel Aviv (IL)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/580,783

(22) PCT Filed: Aug. 19, 2004
(86) PCT No.: PCT/EP04/51849

§ 371 Date: Mar. 31, 2007

(30) Foreign Application Priority Data
Nov. 26, 2003 (GB) 0327453.7

(51) Int. Cl. G05D 23/24

(52) U.S. Cl. 219/494

(57) ABSTRACT

A computer component heater is operably coupled to a pulse width modulation (PWM) power controller, the power controller is operable to automatically vary a duty cycle in relation to the voltage of the power source supplying the heater.

### TECHNICAL FIELD

The invention relates to an apparatus and method of computer component heating. In particular, it relates to an automated apparatus and method of computer component heating.

### BACKGROUND

Unlike desktop computers, portable computing devices can be exposed to a variety of severe operating environments, such as humidity, impact and temperature.

Of the computer's components, hard disks and LCD displays are particularly sensitive to low temperatures;

In the case of a hard disk, thermal expansion or contraction may affect the extremely small clearances between reading head and platter, or affect the balance of the platter when it is spinning at, say, 7200 rpm. Any such alteration can impair read quality or even result in damage to the reading head or platter surface.

In the case of an LCD display, the properties of the liquid crystal are typically temperature-dependant and may result in diminishing display qualities at temperature extremes.

In addition, some battery chemistries used in portable computers also have a preferred temperature range for operating/storage; for example, Lithium-Ion and Nickel Metal-Hydride batteries are typically recommended to operate between −20 and +40° C.

It is known in the art that one solution to this problem is to provide a heater within the computer component, operable to turn on below such a temperature extreme, for up to a maximum period of time (for example, 16 hours, so spanning the time between the typical end of one working day and the start of the next).

In the case of a vehicle-mounted device, the heater may also have a battery protection cut-off, such that if the vehicle battery powering the heater drained below a certain voltage over time, the heater would turn off to prevent the battery being unable to subsequently start the vehicle.

However, both the quality of a battery power supply and the severity of temperature to be countered are unpredictable quantities, making the known heater an imprecise solution.

The purpose of the present invention is to address the above problem.

### SUMMARY OF THE INVENTION

The present invention provides a computer component heater operably coupled to a pulse width modulation (PWM) power controller, said power controller operable to automatically vary a duty cycle in relation to the voltage of the power source supplying the heater.

Advantageously, by using a PWM power controller, the heater output can be controlled largely independently of the power supply voltage by adjustment of the duty cycle.

In a first aspect, the present invention provides a computer component heater operably coupled to a PWM power controller, as claimed in claim 1.

In a second aspect, the present invention provides a method of heating a computer component, as claimed in claim 15.

Further features of the present invention are as defined in the dependent claims.

Embodiments of the present invention will now be described by way of example with reference to the accompanying drawing, in which:

### BRIEF DESCRIPTION OF THE DRAWING

FIG. 1 is a schematic diagram of a computer component heater operably coupled to a PWM power controller in accordance with an embodiment of the present invention.

### DETAILED DESCRIPTION

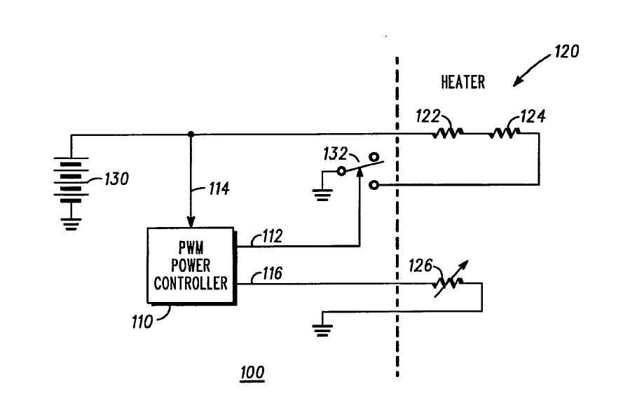

Referring to FIG. 1, an arrangement 100 of a computer component heater operably coupled to a pulse width modulation (PWM) power controller is disclosed.

A heater 120 is operably coupled to a PWM power controller 110.

In an embodiment of the present invention, the heater 120 comprises two heating elements (122, 124) and a temperature sensor 126 such as a thermistor.

The heating element(s) (122, 124) each have a resistance of 10 Ohms, ±10%, resulting in a heater with a resistance of approximately 20 Ohms. This low resistance when compared to heaters known in the art (typically a total of 70 Ohms) allows for higher power dissipation. It will be clear to a person skilled in the art however that a proportion of this benefit may be obtained for any resistance substantially below 70 Ohms, for example between 10 and 50 Ohms.

The PWM power controller 110 comprises a PWM control signal 112 operable to switch supply from the power source 130 on or off via a switching means 132, typically a power transistor.

The power source 130 may be accessed via the computer component to be heated, but preferably is accessed independently, so that the PWM power controller 110 is operable to control the supply from the power source 130 to the heater 120 irrespective of whether the computer component with which it is associated currently has power.

In use the PWM power controller 110 also receives an input 114 indicative of the voltage of the power source 130, and an input 116 indicative of the temperature as measured by temperature sensor 126.

In an embodiment of the present invention, the voltage of the power source 130 is used by the PWM power controller 110 to determine the duty cycle (percentage of time the power is ‘on’, or pulse width) in the PWM power control scheme. By linking the duty cycle to the power source voltage in this manner, in use the PWM power controller 110 automatically varies the duty cycle in relation to the voltage of the power source 130 to the heater 120.

Table 1 below is an example of a look-up table for control of the duty cycle as a function of vehicle battery voltage (an example of power source 130) and of heater 120 output (power dissipation), the latter typically dependent upon either measured temperature (e.g. differential between current temperature and minimum specification of the computer component) or user preference (e.g. maximum wattage):

TABLE 1
Example look-up table for control of the duty
cycle as a function of vehicle battery voltage and heater wattage.

| Heater | Vehicle Battery Voltage | | | | | | | | | | | | | | |
|---|---|---|---|---|---|---|---|---|---|---|---|---|---|---|---|
| Watts | 9.5 | 10 | 10.5 | 11 | 11.5 | 12 | 12.5 | 13 | 13.5 | 14 | 14.5 | 15 | 15.5 | 16 | 16.5 |
| 0 | DC = 0 | 0 | 0 | 0 | 0 | 0 | 0 | 0 | 0 | 0 | 0 | 0 | 0 | 0 | 0 |
| 1.5 | 33% | 30% | 27% | 25% | 23% | 21% | 19% | 18% | 16% | 15% | 14% | 13% | 12% | 12% | 11% |
| 2 | 44% | 40% | 36% | 33% | 30% | 28% | 26% | 24% | 22% | 20% | 19% | 18% | 17% | 16% | 15% |
| 2.5 | 55% | 50% | 45% | 41% | 38% | 35% | 32% | 30% | 27% | 26% | 24% | 22% | 21% | 20% | 18% |
| 3 | 66% | 60% | 54% | 50% | 45% | 42% | 38% | 36% | 33% | 31% | 29% | 27% | 25% | 23% | 22% |
| 3.5 | 78% | 70% | 63% | 58% | 53% | 49% | 45% | 41% | 38% | 36% | 33% | 31% | 29% | 27% | 26% |
| 4 | 89% | 80% | 73% | 66% | 60% | 56% | 51% | 47% | 44% | 41% | 38% | 38% | 33% | 31% | 29% |
| 4.5 | 100% | 90% | 82% | 74% | 68% | 63% | 58% | 53% | 49% | 46% | 43% | 40% | 37% | 35% | 33% |

Alternatively, a parametric description of the relationship between duty cycle, power source voltage and heater output (or difference between current and desired temperature) can be used.

The PWM power controller 110 controls the heater 120 output (wattage) preferentially by driving signal 112 using an on/off oscillation frequency higher than the frequency at which the heater element(s) (122, 124) could thermally cycle (heat and cool) significantly. Consequently any variation in duty cycle has primarily the effect of controlling the mean power dissipated by the element over time. Lower oscillation frequency is possible, but as thermal cycling becomes a factor, the heater element temperature would vary more significantly around the desired mean and risk damage at peak temperatures.

Typically default values for a number of operational parameters will also be provided to the PWM power controller programming, the parameters including:
i. a temperature threshold at which to activate the heater 120;
ii. a degree of hysteresis about the temperature threshold at which to activate/deactivate the heater 120;
iii. a maximum heating duration; and
iv. a battery protection voltage threshold.

Additionally, any or all of the above operational parameters may be modified by user-preference.

The hysteresis defines the desired heating range for the computer component, the lower bound being the temperature threshold at which to activate the heater 120, and the upper bound being the temperature threshold at which to deactivate the heater before it unnecessarily heats the component. So for example the hysteretic-window for a hard disk might be 5 to 7° C., so keeping the hard disk on average two degrees warmer than a minimum operating specification of 4° C.

Whilst clearly the heating element(s) (122, 124) will be placed within or in thermal contact with the computer component (e.g. LCD display, hard disk or LI/NiMH battery), the PWM power controller may either be separate from the computer component, or the computer component may comprise the PWM power controller. It is also contemplated that one PWM power controller may control more than one heater by virtue of multiple inputs and/or outputs.

A method of heating a computer component is also provided, characterised by the steps of;
i. operably coupling a computer component heater to a pulse width modulation (PWM) power controller; and
ii. the power controller automatically varying a duty cycle in relation to the voltage of the power supply to the heater.

It will be understood that the computer component heater operably coupled to a PWM power controller as described above, provides at least one or more of the following advantages:
i. Heater control is related to power source voltage;
ii. Programmable heater control enables the inclusion of user preferences, avoiding the need for hardware changes in different climates.
iii. The use of an adaptive controller can absorb the effects of component variability in maintaining target temperatures.

1. A computer component heater operably coupled to a pulse width modulation (PWM) power controller, said power controller in operation varying a PWM duty cycle in relation to the voltage of the power source supplying the heater.

2. Apparatus according to claim 1 wherein the PWM duty cycle is related to the voltage of the heater's power source via a lookup table.

3. Apparatus according to claim 1, wherein the power controller is operable to further vary a duty cycle in relation to a heater power dissipation dependent upon user preference.

4. Apparatus according to claim 1, wherein the power controller is operable to further vary a duty cycle in relation to a temperature dependent heater wattage.

5. Apparatus according to claim 1, wherein the heater comprises two heating elements with a total resistance in the range of 10 to 50 Ohms.

6. Apparatus according to claim 1, wherein the PWM power controller is operable to control the power supply to the heater irrespective of whether a computer component with which it is associated currently has power.

7. Apparatus according to claim 1, which is operable such that a user may select a temperature threshold at which to activate the heater.

8. Apparatus according to claim 1, which is operable such that a user may select a degree of hysteresis between temperature thresholds at which to activate and deactivate the heater.

9. Apparatus according to claim 1, which is operable such that a user may select a maximum heating duration.

10. Apparatus according to claim 1, which is operable such that a user may select a battery protection voltage threshold.

11. Apparatus according to claim 1, wherein the heater's power supply comprises a vehicle battery.

12. A computer component heater operably coupled to a PWM power controller in accordance with claim 1 wherein the computer component is any one of;
i. a hard disk;
ii. an LCD display; and
iii. a battery.

13. A computer component heater operably coupled to a PWM power controller in accordance claim 12 wherein the computer component comprises the heater.

14. A computer component heater operably coupled to a PWM power controller in accordance with claim 12 wherein the computer component comprises the PWM power controller.

15. A method of heating a computer component characterised by the steps of
i. operably coupling a computer component heater to a pulse width modulation (PWM) power controller; and
ii. the power controller automatically varying a duty cycle in relation to the voltage of the power supply to the heater.

16. (canceled)
